(19) United States
(12) Patent Application Publication
(10) Pub. No.: US 2011/0155084 A1
(43) Pub. Date: Jun. 30, 2011

(54) UPPER CYLINDER HEAD HOUSING FOR USE WITH AN ENGINE AND METHOD OF MAKING THE SAME

(76) Inventor: Scott Joseph Sargeant, Howell, MI (US)

(21) Appl. No.: 12/649,774

(22) Filed: Dec. 30, 2009

(51) Int. Cl. F01L 1/34; F01M 1/06; F02B 77/00

(52) U.S. Cl. 123/90.15; 123/90.33; 123/195 C

(57) ABSTRACT

An upper cylinder head (UCH) housing for use with a vehicle engine is provided. The UCH housing includes a cover body and a variable cam timing (VCT) valve body integrally formed with the cover body. The VCT valve body is configured to at least partially cover a VCT valve assembly coupled to the vehicle engine. The UCH housing further includes a plurality of cam caps integrally formed with the cover body. The plurality of cam caps is configured to receive at least a portion of a cam shaft for securing the cam shaft to a cylinder head.

### BACKGROUND OF THE INVENTION

The embodiments described herein relate generally to an upper cylinder head (UCH) housing for use with an engine and, more particularly to an UCH housing having a plurality of integrated components, wherein the UCH housing is configured to be mounted to a cylinder head assembly of a vehicle engine and the integrated components interface with the cylinder head assembly.

At least some known cylinder head assemblies include a plurality of components that are coupled to a cylinder head and covered with a cam cover. Such components are fabricated separately, manufactured together, dissembled, and reassembled. FIG. 1 is a perspective view of a conventional cylinder head assembly 50 with a cam cover removed. FIG. 2 is a perspective view of a conventional cam cover 52 that may be used with cylinder head assembly 50. Cam cover 52 as shown has a slightly different configuration than cylinder head assembly 50 and is used for illustrative purposes only. Cylinder head assembly 50 includes a cylinder head 54, a variable cam timing (VCT) valve body 56, a plurality of cam caps 58, a plurality of spark plug tubes 60, and a fuel pump pedestal 62. VCT valve body 56, cam caps 58, spark plug tubes 60, and fuel pump pedestal 62 are each coupled separately to cylinder head 54. A cam cover, such as cam cover 52, is coupled to cylinder head 54 to cover cylinder head 54, VCT valve body 56, and cam caps 58. Spark plug tubes 60 and/or fuel pump pedestal 62 may extend through respective openings 64 and 66 in cam cover 52 when assembled.

VCT valve body 56 houses oil control valves and provides routing passages for high pressure oil to support a variable cam timing system. Fuel pump pedestal 62 serves as a mounting pedestal for a fuel pump, such as a direct injection fuel pump, and provides access to the cam shaft for fuel pump actuation. When cylinder head assembly 50 includes an oil separator, walls extend from an interior surface of a top wall 67 of cam cover 52 toward cam caps 58 and/or a top surface of cylinder head 54. A baffle plate is coupled within an inner cavity of the cam cover 52 over the walls to define the oil separator. A clearance space is defined between the baffle plate and cam caps 58. As such, an overall height of cylinder head assembly 50 includes a height of cam caps 58, a height of the clearance space, a height of the oil separator walls, and a height of cam cover 52. To access the oil separation plate, cam cover 52 is removed from cylinder head assembly 50.

To assemble cylinder head assembly 50, inlet and exhaust valves are inserted into cylinder head 54. An intake cam shaft is positioned substantially parallel to a longitudinal axis 68 of cylinder head 54 within a first series 70 of cradles 72, and an exhaust cam shaft is positioned substantially parallel to longitudinal axis 68 of cylinder head 54 within a second series 74 of cradles 72. Cams of the intake cam shaft are positioned adjacent top ends of the inlet valves, and cams of the exhaust cam shaft are positioned adjacent top ends of the exhaust valves. Cam caps 58 are coupled to each cradle 72 in second series 74 of cradles 72 to secure the exhaust cam shaft to cylinder head 54, and one cam cap 58 is coupled to a first cradle 76 of first series 70 of cradles 72. Fuel pump pedestal 62 is coupled to the remaining two cradles 72 of first series 70 to secure the intake cam shaft to cylinder head 54. Spark plug tubes 60 are inserted into spark plug openings 78 defined in cylinder head 54, and VCT valve body 56 is coupled to cylinder head 54.

After coupling VCT valve body 56, cam caps 58, spark plug tubes 60, and fuel pump pedestal 62 to cylinder head 54, cam cover 52 is positioned over VCT valve body 56, cam caps 58, spark plug tubes 60, and fuel pump pedestal 60 and is coupled to cylinder head 54. A portion of fuel pump pedestal 62 and/or spark plug tubes 60 may extend above an exterior surface 80 of top wall 67. To service components of cylinder head assembly 50, such as sensors and/or spark plugs, at least cam cover 52 must be removed to access components of cylinder head assembly 50.

To manufacture cylinder head assembly 50, each component is formed individually. A conventional manufacturing process includes partially assembling cylinder head assembly 50 and machining the components together to insure proper fit of the cam shafts to cylinder head 54. More specifically, cam caps 58, VCT valve body 56, and fuel pump pedestal 62 are each fabricated separately then coupled to cylinder head 54. Cam caps 58, VCT valve body 56, fuel pump pedestal 62, and cylinder head 54 are machined together to ensure a proper fit among components.

Cam caps 58, VCT valve body 56, and fuel pump pedestal 62 are then disassembled from cylinder head 54 after machining. Cam caps 58, VCT valve body 56, and fuel pump pedestal 62 are cleaned and sent to an assembly line. Cam caps 58, VCT valve body 56, and fuel pump pedestal 62 are then re-assembled and mounted to cylinder head 54 after the cam shafts and valve train components are positioned in cylinder head 54, as described above. After assembly of cam caps 58, VCT valve body 56, and fuel pump pedestal 62 to cylinder head 54, cam cover 52 is coupled to cylinder head 54, and the partially assembled engine proceeds on with the assembly process. As such, the conventional manufacturing process is time-consuming because each component must be machined separately, assembled for any final machining to ensure a proper fit, and then disassembled prior to final assembly. Because the cylinder head assembly is machined together, each component only fits with a particular cylinder head assembly.

At least one known cylinder head assembly includes a cam cover having cam caps formed integrally therein. However, a variable cam timing valve body, and/or a fuel pump pedestal are separate from the cam cover and coupled to the cam cover during assembly. Accordingly, such a cam cover encounters the same problems mentioned above, namely, disassembly during servicing and an extensive manufacturing process.

As such, it is desirable to provide a cam cover that can be manufactured with fewer steps. It is also desirable to provide a cylinder head assembly that includes fewer components than the cylinder head assembly with the conventional cam cover to ease manufacturing and assembly processes. It is further desirable to provide a cam cover having a plurality of engine components integral to the cam cover, wherein the cam cover is configured to be mounted to a cylinder head assembly and the integrally formed engine components interface with the cylinder assembly.

### BRIEF SUMMARY OF THE INVENTION

In one aspect, an upper cylinder head (UCH) housing for use with a vehicle engine is provided. The UCH housing includes a cover body and a variable cam timing (VCT) valve body integrally formed with the cover body. The VCT valve body is configured to at least partially cover a VCT valve assembly coupled to the vehicle engine. The UCH housing further includes a plurality of cam caps integrally formed with the cover body. The plurality of cam caps is configured to receive at least a portion of a cam shaft for securing the cam shaft to a cylinder head.

In another aspect, an engine for a vehicle is provided. The engine includes a cylinder head configured to at least partially encase at least one piston and at least one cam shaft, a variable cam timing (VCT) valve assembly coupled to the at least one cam shaft, and an upper cylinder head (UCH) housing coupled to an upper portion of the cylinder head. The UCH housing includes a cover body and a VCT valve body integrally formed with the cover body. The VCT valve body is configured to at least partially cover the VCT valve assembly. The UCH housing further includes a plurality of cam caps integrally formed with the cover body. The plurality of cam caps is configured to receive at least a portion of the least one cam shaft for securing the at least one cam shaft to the cylinder head.

In yet another aspect, a method of making a cylinder head assembly is provided. The method includes providing an upper cylinder head (UCH) housing including a cover body, a variable cam timing valve body integrally formed with the cover body, and a plurality of cam caps integrally formed with the cover body. The method further includes coupling the UCH housing to a cylinder head, machining the UCH housing and the cylinder head together, and disassembling the UCH housing from the cylinder head.

In still another aspect, a method of making an upper cylinder includes forming a cover body, a variable cam timing (VCT) valve body, and a plurality of cam caps unitarily as one piece. The VCT valve body is configured to at least partially cover a VCT valve assembly coupled to the vehicle engine, and the plurality of cam caps is configured to receive at least a portion of a cam shaft for securing the cam shaft to a cylinder head.

### BRIEF DESCRIPTION OF THE DRAWINGS

FIGS. 1-15 show exemplary embodiments of the apparatus and methods described herein.

FIG. 1 is a perspective view of a conventional cylinder head assembly.

FIG. 2 is a perspective view of a conventional cam cover that may be used with the cylinder head assembly shown in FIG. 1.

FIG. 3 is a partially cut-away perspective view of an exemplary engine.

FIG. 4 is a right perspective, partially cut-away view of an exemplary upper engine assembly that may be used with the engine shown in FIG. 3.

FIG. 5 is a left perspective, partially cut-away view of the upper engine assembly shown in FIG. 4.

FIG. 6 is a top perspective, partially cut-away view of the upper engine assembly shown in FIG. 4.

FIG. 7 is a perspective view of an exemplary upper cylinder head (UCH) housing that may be used with the upper engine assembly shown in FIGS. 4-6.

FIG. 8 is a top perspective view of the UCH housing shown in FIG. 7 with a baffle plate removed.

FIG. 9 is a bottom perspective view of the UCH housing shown in FIG. 7.

FIG. 10 is a front elevation view of the UCH housing shown in FIG. 7.

FIG. 11 is a rear elevation view of the UCH housing shown in FIG. 7.

FIG. 12 is a right side elevation view of the UCH housing shown in FIG. 7.

FIG. 13 is a left side elevation view of the UCH housing shown in FIG. 7.

FIG. 14 is a top plan view of the UCH housing shown in FIG. 7.

FIG. 15 is a bottom plan view of the UCH housing shown in FIG. 7.

### DETAILED DESCRIPTION OF THE INVENTION

The embodiments described herein include a unitary upper cylinder head (UCH) housing that includes a plurality of engine components integrated therein including at least cam caps and a variable cam timing (VCT) valve body. The unitary UCH housing can also include a fuel pump pedestal, an oil separator, an oil fill hole, a dip stick tube, and/or a sensor platform by integrating these components into the UCH housing. To perform the above-mentioned functions, each of these components is no longer required to be separately manufactured and then assembled.

As used herein, the term “integral” or “integrally” refers to components being permanently attached to each other by, for example, welding or other mechanical or chemical fasteners, to form the components into one piece. Further, as referred to herein, the term “unitary” or “unitarily” refers to components that are formed as one piece.

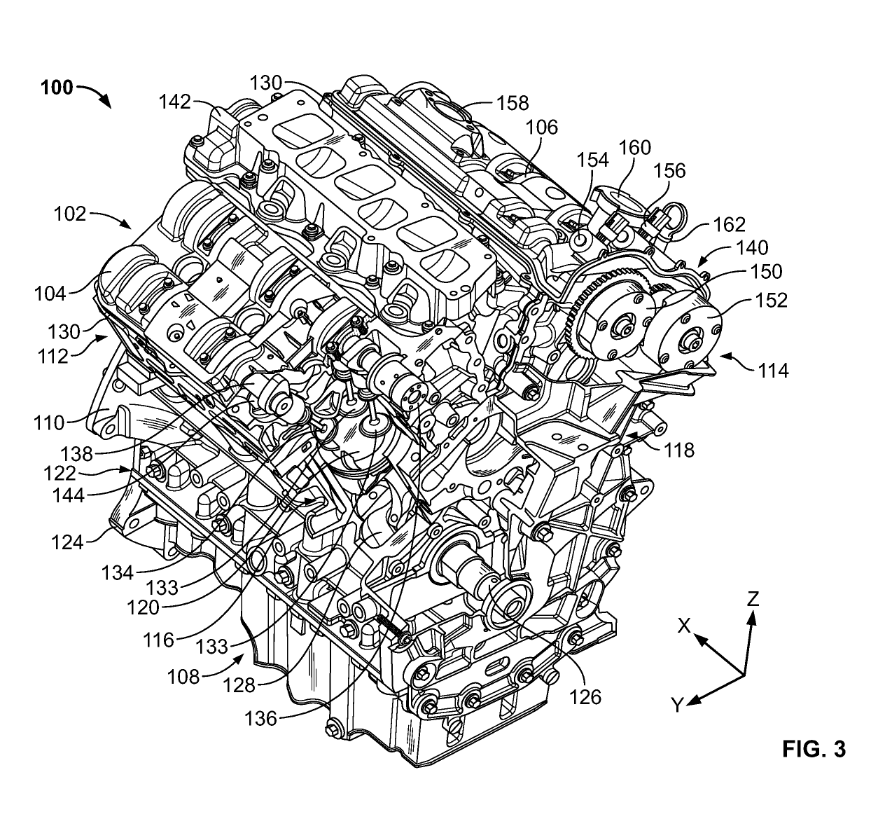

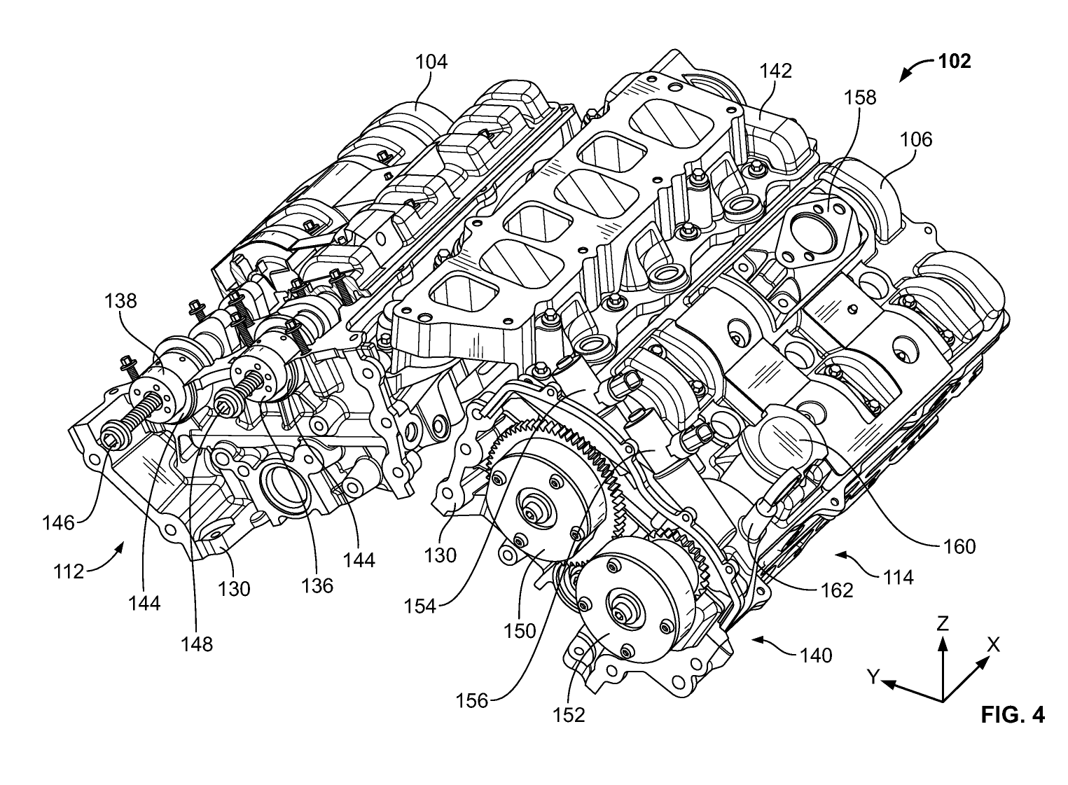

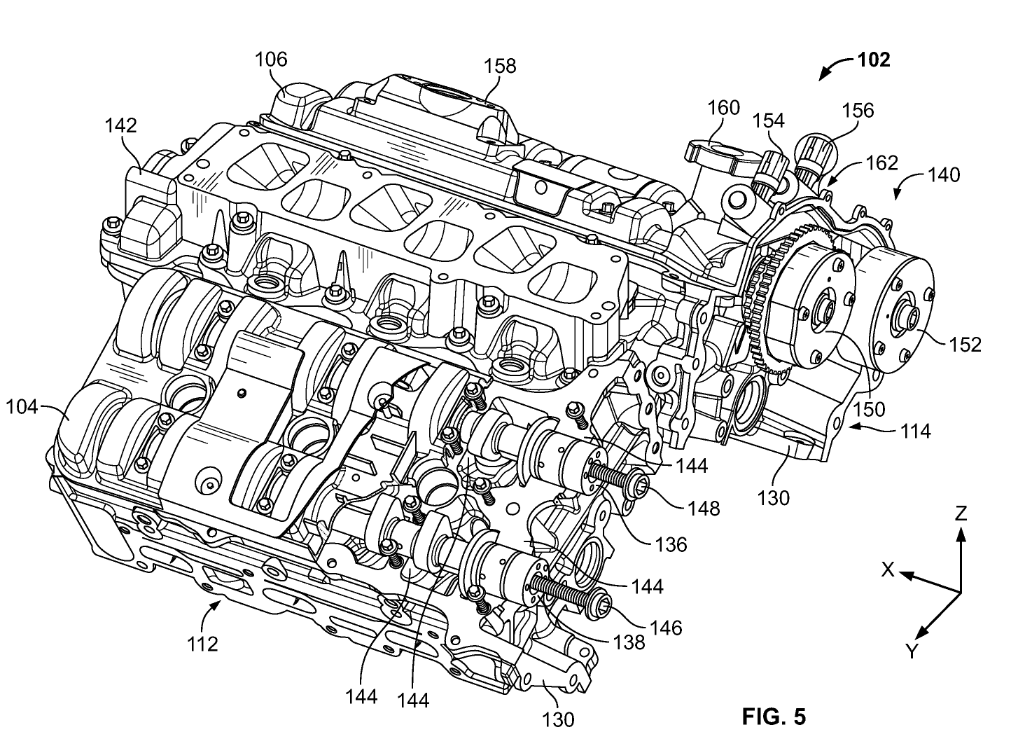

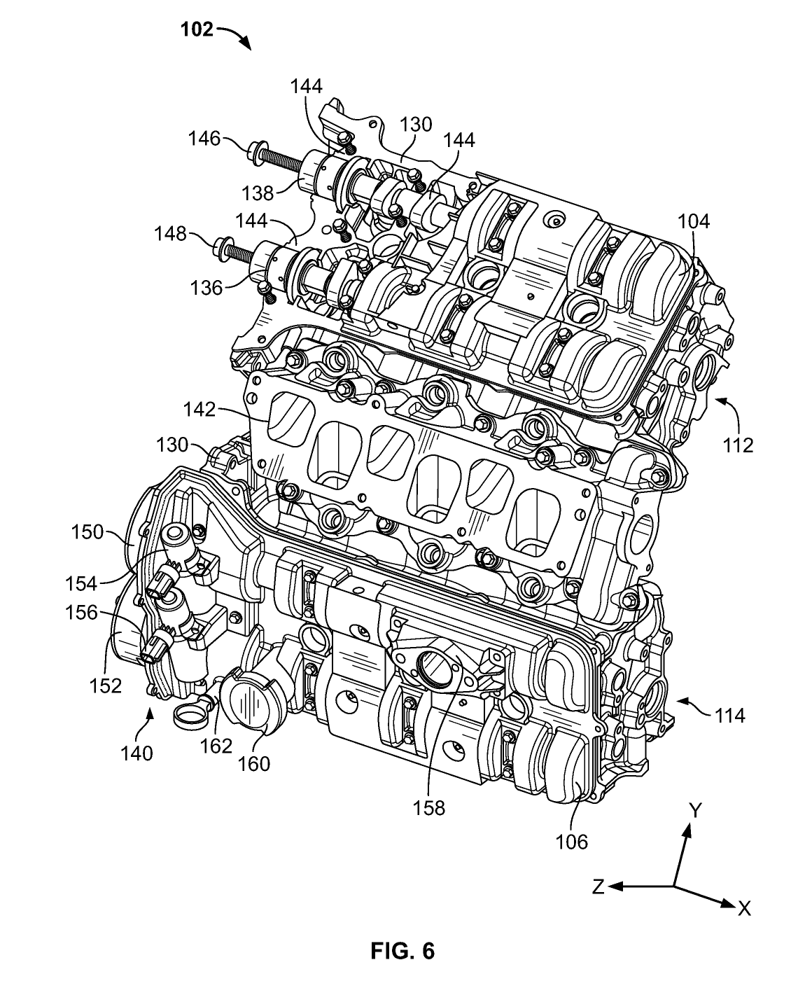

FIG. 3 is a partially cut-away perspective view of an exemplary engine 100 that may be used in a vehicle. FIG. 4 is a right perspective, partially cut-away view of an exemplary upper engine assembly 102 that may be used with engine 100. FIG. 5 is a left perspective, partially cut-away view of upper engine assembly 100. FIG. 6 is a top perspective, partially cut-away view of upper engine assembly 102. In the exemplary embodiment, engine 100 is an internal combustion engine having a V6 configuration, however, it should be understood that engine 100 may be any suitable engine, such as a V8 engine, an inline engine, and/or a diesel engine. A “V” configured engine includes two UCH housings, and an inline engine includes one upper cylinder head (UCH) housing. Further, in a “V” configured engine, two differently configured UCH housings, such as UCH housings 104 and 106, can be used. The components and operation of engine 100 are described herein for exemplary purposes; however, someone skilled in the art will understand how the engine described herein is configured and operates.

In the exemplary embodiment, engine 100 includes a crankcase 108, a block 110, and upper engine assembly 102. Upper engine assembly 102 includes two cylinder head assemblies 112 and 114. Block 110 is coupled to crankcase 108, and cylinder head assemblies 112 and 114 are coupled to block 110. Block 110 includes a first cylinder bank 116 and a second cylinder bank 118. First cylinder bank 116 and second cylinder bank 118 are oppositely inclined and upwardly diverging to form a generally V-shaped configuration. Each cylinder bank 116 and 118 has defined therein three engine cylinders, in which respective pistons 120 are reciprocally mounted, as described in more detail below. Further, block 110 has a bottom opening 122 defined at a lower marginal edge. An oil pan 124 is fluid-tightly secured to bottom opening 122 to define crankcase 108.

Within crankcase 108, a crankshaft 126 is rotatably supported in block 110 at front and rear end walls of block 110. Crankshaft 126 converts an up-and-down motion of pistons 120 into rotary motion. The rotary motion provides turning motion for effecting a mechanical movement, such as a movement of wheels of a vehicle. Crankshaft 126 is coupled to pistons 120 via respective connecting rods 128. Connecting rods 128 extend from crankshaft 126 through a cylinder bank 116 or 118 to a respective piston 120. Crankshaft 126 and connecting rods 128 are configured to move pistons 120 through cylinder banks 116 and 118 and cylinder head assemblies 112 and 114. Cylinder head assemblies 112 and 114 each include a cylinder head 130, intake valves 132, exhaust valves 134, an intake cam shaft 136, an exhaust cam shaft 138, a variable cam timing assembly 140, and an UCH housing 104 or 106.

Each cylinder head 130 is fluid-tightly coupled on top of a respective cylinder bank 116 or 118 through a gasket. Further, each cylinder head 130 includes intake ports and exhaust ports. Each intake port is in flow communication with a respective cylinder and an intake manifold 142. Intake manifold 142 is positioned in part within the V-shaped space between first cylinder bank 116 and second cylinder bank 118 and in part above the V-shaped space. Intake piping may be connected between intake manifold 142 and each intake port. Each exhaust port is in communication with a respective cylinder and an exhaust system.

Further, each intake port includes at least one intake valve 132 for controlling a flow of an air-fuel mixture into an associated cylinder. In the exemplary embodiment, two intake valves 132 are positioned in each intake port. Similarly, each exhaust port includes at least one exhaust valves 134 for controlling a discharge of exhaust gases from the associated cylinder. In the exemplary embodiment, two exhaust valves 134 are positioned in each exhaust port. Intake valves 132 and exhaust valves 134 can each include a spring to bias valve 132 and/or 134 in a closed position. Intake valves 132 and exhaust valves 134 are each in contact with, or coupled to, a respective cam shaft 136 or 138. More specifically, a top of each valve 132 and 134 is in contact with a cam of cam shaft 136 or 138. In the exemplary embodiment, cam shafts 136 and 138 are each roller finger type shaft; however, it should be understood that cam shafts 136 and/or 138 can be any suitable type of cam shaft, such as a cam shaft that utilizes direct actuation using mechanical brackets.

Cam shafts 136 and 138 are positioned within shaft cradles 144 of cylinder head 130. At front ends 146 and 148 of cam shafts 136 and 138, respectively, a variable cam timing (VCT) valve assembly 140 is coupled. More specifically, a first actuator 150 is coupled to intake cam shaft 136, and a second actuator 152 is coupled to exhaust cam shaft 138. Alternatively, engine 100 includes any suitable variable valve timing assembly. In the exemplary embodiment, each actuator 150 and 152 includes a respective oil valve 154 or 156 for channeling oil to and from actuator 150 or 152. Oil valves 154 and 156 are coupled to each UCH housing 104 and 106, as described in more detail below. Further, actuators 150 and 152 and cam shafts 136 and 138 are protected and covered by UCH housing 104 or 106. In the exemplary embodiment, first cylinder head assembly 112 includes first UCH housing 104, and second cylinder head assembly 114 includes second UCH housing 106 configured differently than first UCH housing 104.

More specifically, in the exemplary embodiment, first UCH housing 104 is configured to house and/or define VCT valve assembly 140 and cam shafts 136 and 138, and second UCH housing 106 is configured to house and/or define VCT valve assembly 140, cam shafts 136 and 138, a fuel pump pedestal 158, an oil fill access 160, and a dip stick access 162. First UCH housing 104 is not configured to accommodate a fuel pump, an oil fill access, and a dip stick access because engine 100 includes one fuel pump, one oil fill access, and one dip stick access. It should be understood that UCH housings 104 and/or 106 can have any suitable configurations based on the type of engine that UCH housings 104 and/or 106 are used with. For example, in an alternative embodiment, UCH housings 104 and 106 have substantially the same configuration.

During operation of engine 100, when intake valves 132 are pushed open by a cam of cam shaft 136, piston 120 travels downward pulling an air/fuel charge into the cylinder. The intake charge is a mixture of air and fuel and is ready for combustion. Piston 120 is pushed upward by crankshaft 126. A spark plug ignites the air/fuel mixture to force piston 120 downward, which rotates crankshaft 126. Piston 120 is then pushed upward by crankshaft 126 to push exhaust valves 134 open, which allows exhaust gases to be channeled from the cylinder, through the exhaust port, to the exhaust system. Once piston 120 is at the top position, piston 120 can again pull air and fuel into the cylinder.

Further, during operation of engine 100, VCT valve assembly 140 adjusts a cam-to-crankshaft timing depending on changes in engine speed and load. An engine computer coupled in communication with VCT valve assembly 140 can perform calculations and adjustments to the cam-to-crankshaft timing. Pressurized engine oil is controlled by the engine computer through oil control valves 154 and/or 156 which allows engine oil to flow to VCT actuators 150 and/or 152. When the oil is forced into VCT actuator 150 and/or 152, the camshaft timing advances. When the oil pressure is released, a return spring supplies force to return VCT actuator 150 and/or 152 to a standard position.

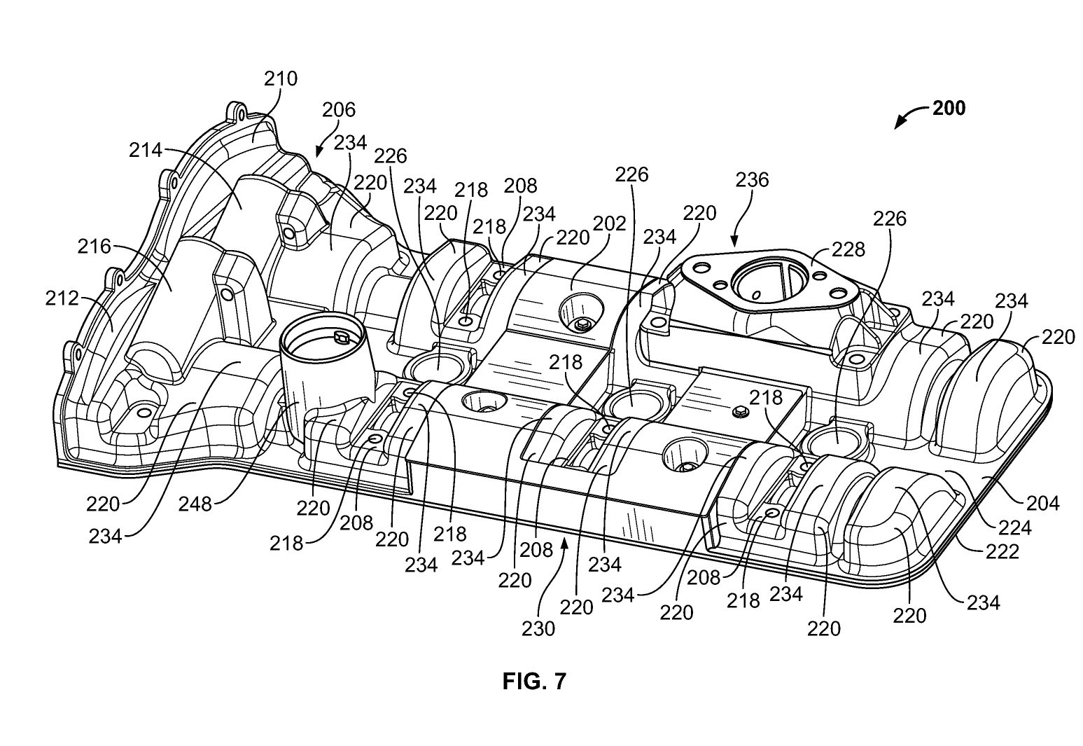

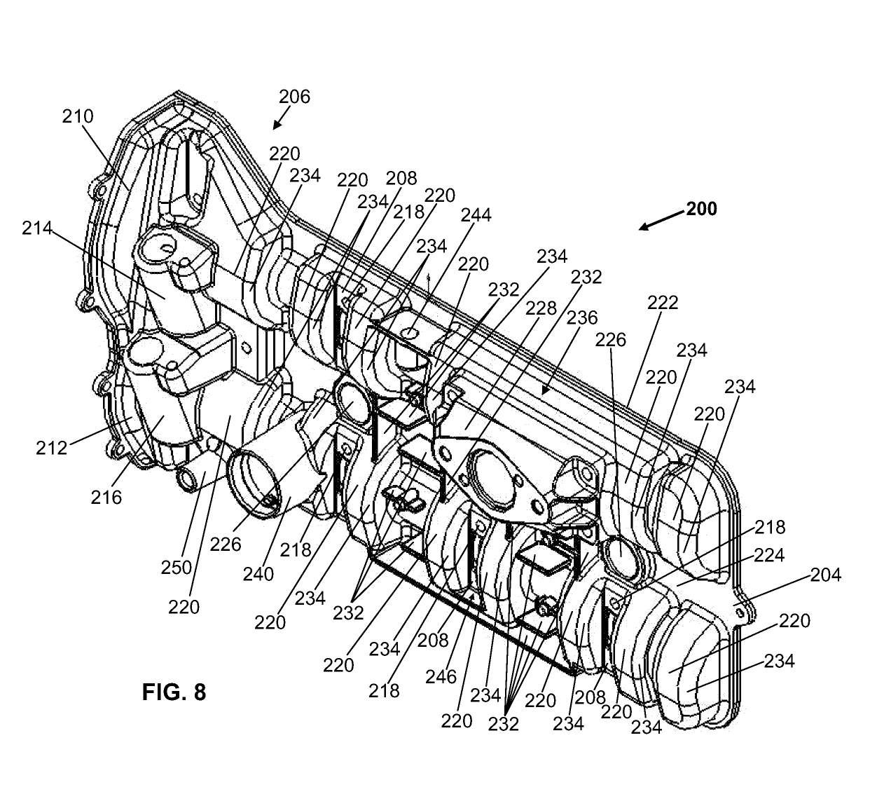

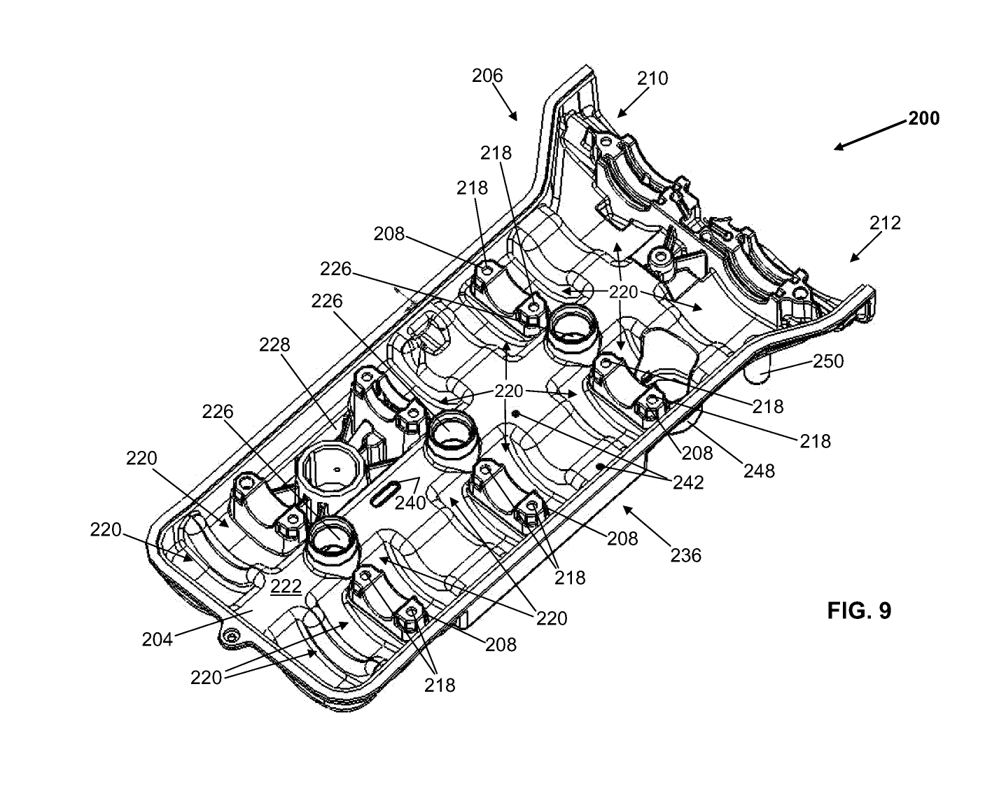

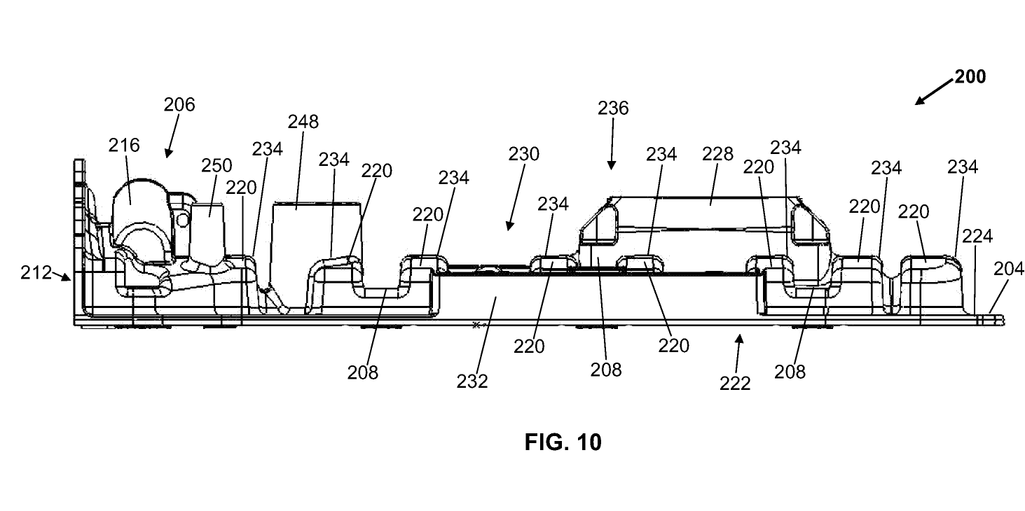

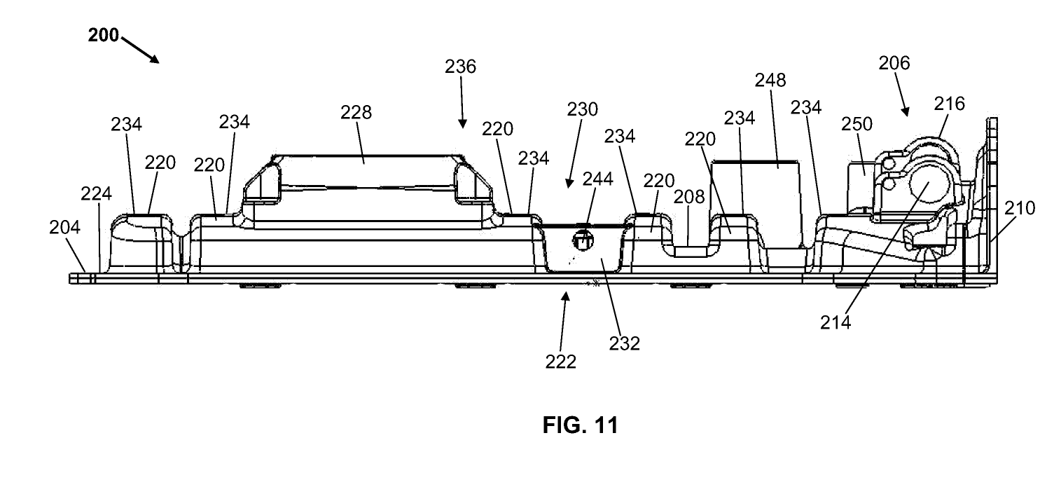

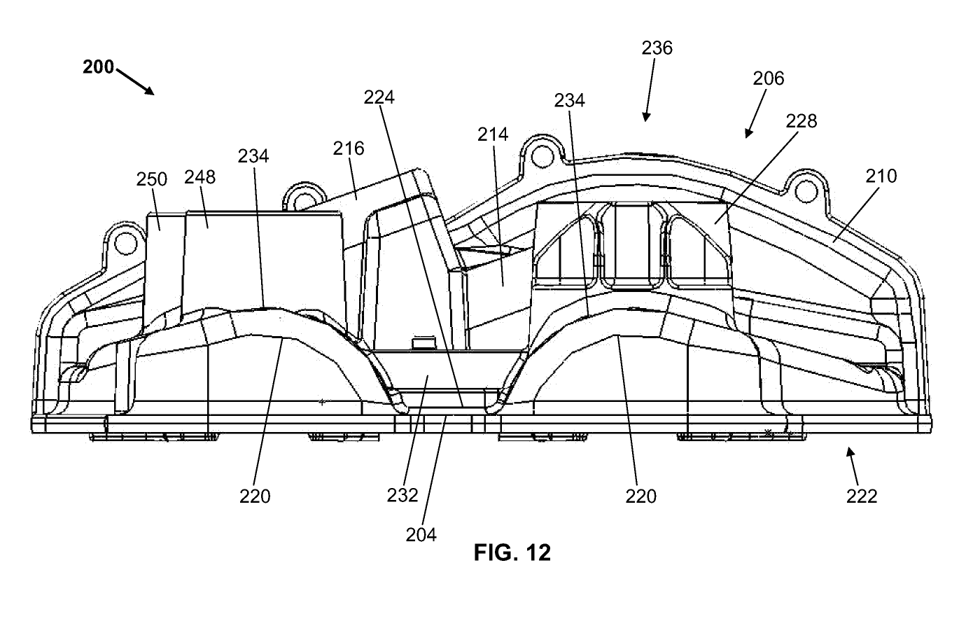

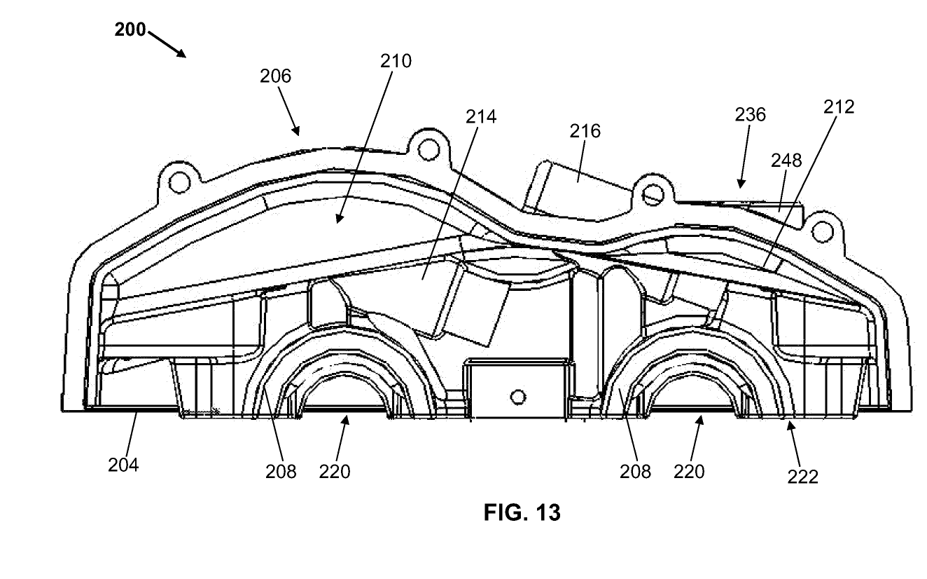

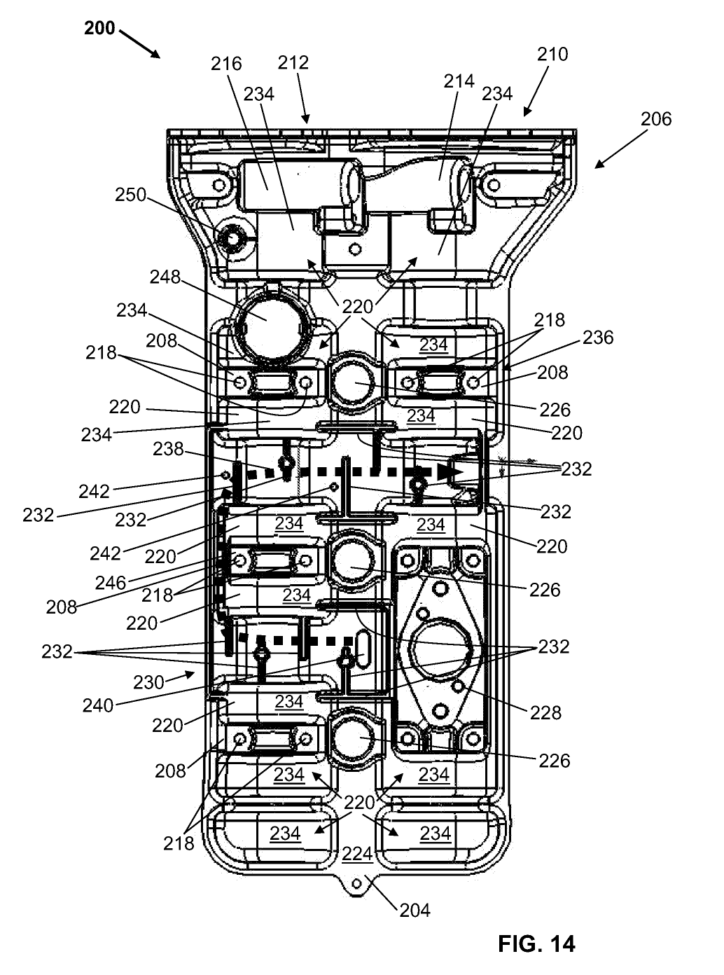

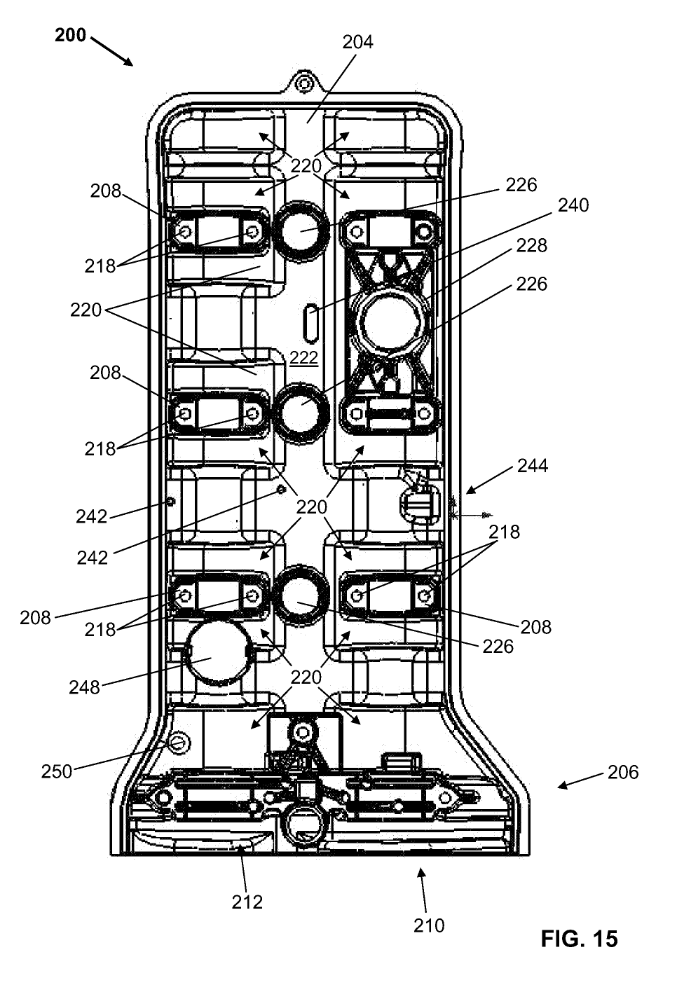

FIG. 7 is a perspective view of an exemplary UCH housing 200 that may be used with upper engine assembly 102 (shown in FIGS. 4-6). FIG. 8 is a top perspective view of UCH housing 200 with an oil separator baffle plate 202 (shown in FIG. 7) removed. FIG. 9 is a bottom perspective view of UCH housing 200. FIG. 10 is a front elevation view of UCH housing 200. FIG. 11 is a rear elevation view of UCH housing 200. FIG. 12 is a right side elevation view of UCH housing 200. FIG. 13 is a left side elevation view of UCH housing 200. FIG. 14 is a top plan view of UCH housing 200. FIG. 15 is a bottom plan view of UCH housing 200.

UCH housing 200 illustrated in FIGS. 7-15 may be used as UCH housing 106 (shown in FIGS. 3-6). It should be understood that the description of UCH housing 200, including the engine components integrated therein, is also applicable to UCH housing 106 and UCH housing 104 (shown in FIGS. 3-6). In other words, aspects of UCH housing 200 are also applicable to UCH housings 104 and 106, except UCH housing 104 does not include a fuel pump pedestal 228, an oil fill hole 248, or a dip stick tube 250.

In the exemplary embodiment, UCH housing 200 includes a cover body 204, a VCT valve body 206, and a plurality of cam caps 208. VCT valve body 206 and cam caps 208 are integrally or unitarily formed with cover body 204. In the exemplary embodiment, VCT valve body 206 and cam caps 208 are unitarily formed as one piece with cover body 204. VCT valve body 206 is configured to at least partially cover and/or encase a VCT valve while allowing access for a drive chain to be mounted to sprockets of the VCT valve. More specifically, VCT valve body 206 includes an intake actuator housing 210, an exhaust actuator housing 212, an intake oil control valve port 214, and an exhaust oil control valve port 216 integrally or unitarily formed with cover body 204.

In the exemplary embodiment, housings 210 and 212 partially encase and/or cover a rear portion of a respective VCT actuator 150 or 152 (shown in FIGS. 3-6). For example, housings 210 and 212 end at a location with respect to VCT actuators 150 and/or 152 such that a space is provided at ends of housings 210 and 212 to mount a drive chain to VCT actuators 150 and/or 152. In a particular embodiment, housings 210 and 212 do not cover and/or encase teeth of the sprockets of VCT actuators 150 and 152. In the exemplary embodiment, oil control valve ports 214 and 216 are configured to receive oil controls valves 154 and/or 156 (shown in FIGS. 3-6) that channel the oil into and out of actuators 150 and 152 (shown in FIGS. 3-6), respectively. VCT valve body 206 is also configured to be coupled in flow communication to a high pressure oil port (not shown) in cylinder head 130.

Cam caps 208 are configured to receive at least a portion of cam shaft 136 or 138 to secure cam shaft 136 or 138 to cylinder head 130. In the exemplary embodiment, cap caps 208 secure cam shafts 136 and 138 to cylinder head by coupling UCH housing 200 to cylinder head 130 (shown in FIGS. 3-6). More specifically, in the exemplary embodiment, each cam cap 208 includes apertures 218 for receiving fasteners to couple UCH housing 200 to cylinder head 130 at cradles 144 (shown in FIGS. 3-6). Alternatively, cam caps 208 secure cam shafts 136 and 138 to cylinder head 130 via any suitable means.

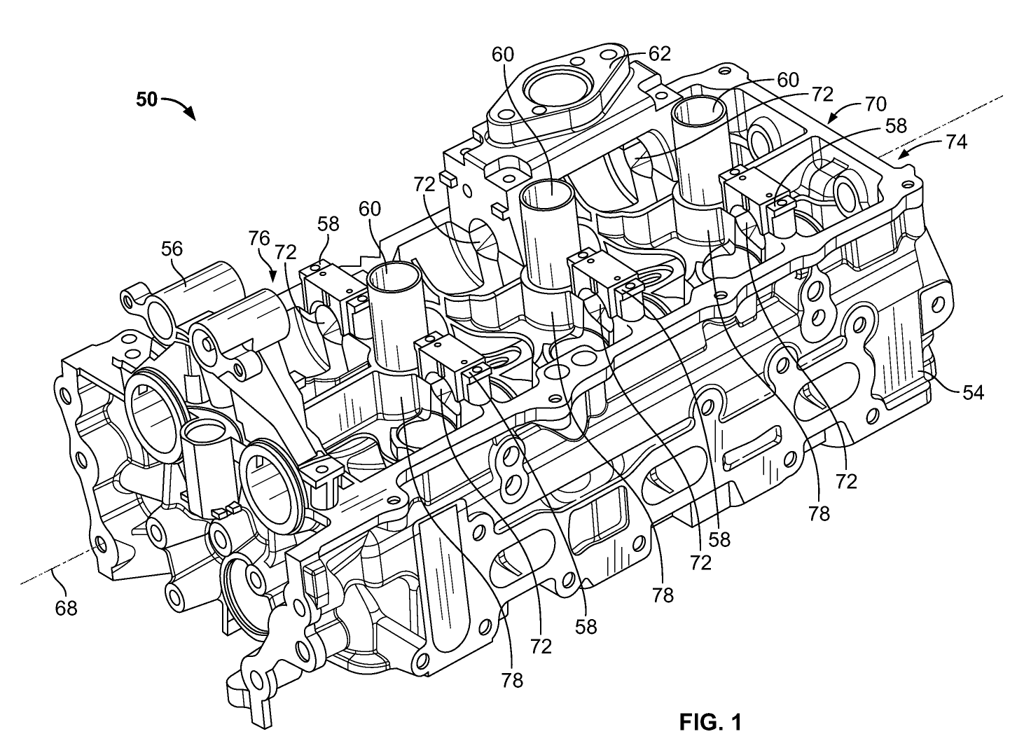

UCH housing 200 includes a plurality of cam chambers 220 defined therein. More specifically, each cam chamber 220 is defined by an indentation in an interior surface 222 of UCH housing 200. As such, each cam chamber 220 extends upward from an exterior surface 224 of cover body 204. Cam chambers 220 correspond to each cam shaft 136 and/or 138 to enable cam shafts 136 and 138 to rotate within UCH housing 200. In the exemplary embodiment, each cam chamber 220 is configured to at least partially encase a respective cam. In other words, each cam chamber 220 is configured to receive at least a portion of a respective cam such that the cam is able to rotate within a respective cam chamber 220. As such, UCH housing 200 is contoured to correspond to cam shafts 136 and 138. Further, UCH housing 200 is sculpted to cam shafts 136 and 138 to reduce a package height of cylinder head assembly 112 and/or 114 (shown in FIGS. 3-6) as compared to conventional cylinder head assemblies, such as cylinder head assembly 50 (shown in FIG. 1).

In the exemplary embodiment, UCH housing 200 includes at least one spark plug access opening 226 defined through cover body 204. In a particular embodiment, spark plug tubes can be formed integrally or unitarily as one piece with cover body 204, however, the configuration of UCH housing 200 may eliminate the need for spark plug tubes. In the exemplary embodiment, each spark plug opening 226 is sized to receive a spark plug and associated components, such as wiring, therein. UCH housing 200 further includes a fuel pump pedestal 228 integrally or unitarily formed as one piece with cover body 204. Fuel pump pedestal 228 is configured to couple a direct inject fuel pump to UCH housing 200. Alternatively, UCH housing 200 does not include fuel pump pedestal 228 when, for example, engine 100 (shown in FIG. 3) does not include the direct inject fuel pump.

UCH housing further includes, in the exemplary embodiment, an oil separator 230. Oil separator 230 is integrally or unitarily formed as one piece with cover body 204. Oil separator 230 includes baffle plate 202 and a plurality of walls 232. Walls 232 are formed integrally or unitarily as one piece with cover body 204, and baffle plate 202 is coupled to UCH housing 200. In the exemplary embodiment, oil separator 230 is defined along body exterior surface 224 and an exterior surface 234 of cam chambers 220. Oil separator 230 is configured to separate oil from gaseous vapors. Gaseous vapors include air, exhaust, and/or any other suitable compounds in gaseous state. In the exemplary embodiment, oil separator 230 covers a substantial portion of an upper surface 236 of UCH housing 200. For example, in a particular embodiment, oil separator 230 can cover between about 50% and about 90% of upper surface 236.

In the exemplary embodiment, walls 232 are defined between cam chambers 220 to at least partially define a flow pathway 238 (shown in FIG. 14) that is configured to control a flow of oil and vapors to remove the oil from the vapors, as described in more detail below. Baffle plate 202 is coupled to UCH housing 200 to enclose and/or covers walls 232 and pathway 238 to retain the oil and the vapors within oil separator 230. Alternatively, UCH housing 200 does not include oil separator 230 when, for example, engine 100 includes a supercharger.

In the exemplary embodiment, oil separator 230 further includes a pick up opening 240, at least one drain back opening 242, and at least one vapor outlet 244. Pathway 238 is in flow communication with pick up opening 240, drain back openings 242, and vapor outlet 244. Pathway 238 is at least partially defined by body exterior surface 224 and exterior surface 234 of cam chambers 220. In the exemplary embodiment, pathway 234 is also partially defined by one cam cap 246 and walls 232 extending from cam chambers 220 or between cam chambers 220. It should be understood that pathway 238 may have any suitable configuration that enables oil separator 230 to function as described herein and is not limited to be being defined by exterior surfaces 224 and 234, cam cap 246, and/or walls 232.

Walls 232 are configured to control and/or vary a flow of oil and vapors along pathway 238 through oil separator 230. In the exemplary embodiment, walls 232 are configured to channel the oil and the vapors such that the oil clings to wall 232 and precipitates from the vapors. More specifically, walls 232 extend upwardly away from body exterior surface 224 and extend between exterior surface 234 of cam chambers 220. At least some walls 232 are in contact with two cam chambers 220 and other walls 232 are in contact with one cam chamber 220.

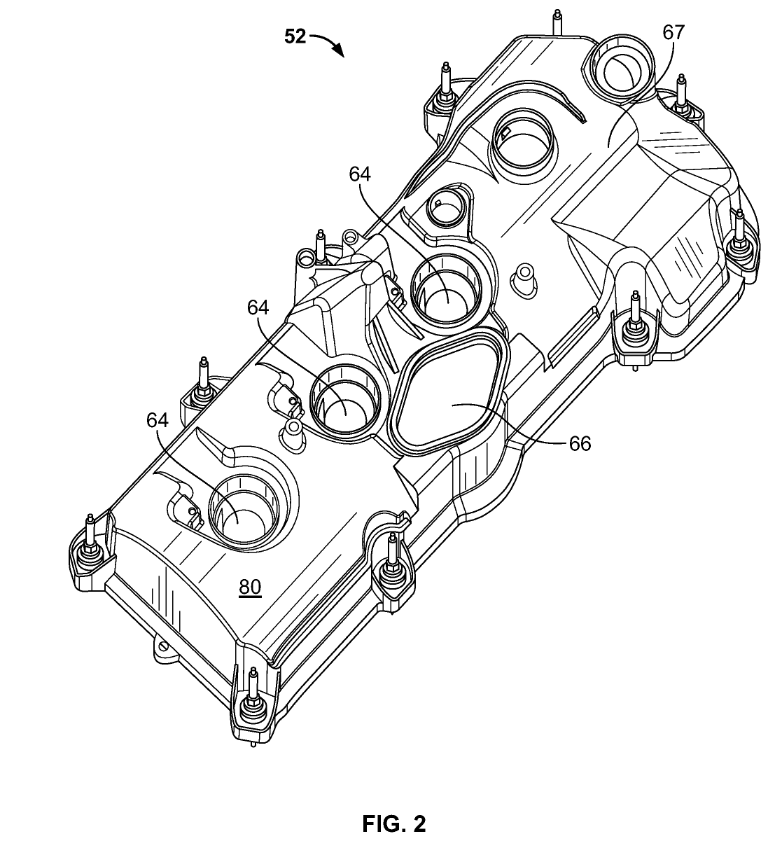

Because walls 232 extend from exterior surfaces 224 and 234 of UCH housing 200 between cam chambers 220, an overall height of cylinder head assembly 112 and/or 114 is reduced. More specifically, the overall height of cylinder head assembly 112 and/or 114 includes a height of cylinder head 130 and a height of UCH housing 200. There is no extra height requirement for oil separator walls 232 and baffle plate 202. More specifically, walls 232 are defined within spaces between cam chambers 220, and baffle plate 202 is substantially at the same height as a height of cam chambers 220. As such, oil separator 230 has substantially the same height as cam chambers 220 as is compacted into spaces formed between other components of UCH housing 200. Further, no clearance space is needed between baffle plate 202 and cam caps 208 in UCH housing 200; however, as described above, a clearance space is needed when a conventional cam cover is used. Accordingly, cylinder head assemblies 112 and/or 114 that includes UCH housing 200 have a smaller overall height as compared to a cylinder head assembly 50 having a conventional cam cover 52 (shown in FIG. 2).

During operation of oil separator 230, the oil and vapor mixture enters pathway 238 through pick up opening 240. The oil and vapor mixture is channeled along pathway 238 by baffle plate 202, walls 232, cam chamber exterior surface 234, and body exterior surface 224. As the oils and vapors flow along pathway 238, the oil clings to walls 232 and/or surfaces 224 and/or 234, which separates the oil from the vapors. The oil flows back into cylinder head assembly 112 and/or 114 through drain back opening(s) 242, and the vapors are discharged from cylinder head assembly 112 and/or 114 through vapor outlet 244. In the exemplary embodiment, the vapors are channeled from vapor outlet 244 to intake manifold 142 (shown in FIGS. 3-6).

In the exemplary embodiment, UCH housing 200 further includes an oil fill hole 248 integrally or unitarily formed as one piece with cover body 204. Oil fill hole 248 is in fluid communication with an oil reservoir of engine 100, such as oil pan 124. Oil fill hole 248 is defined through cover body 204 and is configured to retain an oil cap thereon. For example, an inner and/or outer surface of oil fill hole 248 may be threaded to correspond to threading defined on an oil cap. A dip stick tube 250 can also be integrally or unitarily formed as one piece with cover body 204. Dip stick tube 250 is configured to retain an oil dip stick therein for determining a level of oil within engine. In a particular embodiment, dip stick tube 250 is located near oil separator 230. In alternative embodiments, UCH housing 200 can include a cam position sensor and/or a sensor platform. In the exemplary embodiment, UCH housing 200 incorporates all the functions of cam caps 208, VCT valve body 206, fuel pump pedestal 228, and oil separator 230. UCH housing 200 can further incorporate the functions of an oil fill hole 248, a dip stick tube 250, and a sensor platform. Alternatively, UCH housing 200 does not include oil fill hole 248, dip stick tube 250, and/or a sensor platform.

Referring to FIGS. 3 and 7-15, to manufacture UCH housing 200, UCH housing 200 is fabricated and coupled to cylinder head 130 at, for example, cam caps 208 and fuel pump pedestal 228. UCH housing 200 and cylinder head 130 are machined together prior to engine assembly. During machining, separate components, such as cam caps, a valve body, a fuel pump pedestal, and spark plug tubes, are not machined. After UCH housing 200 and cylinder head 130 are machined, UCH housing 200 is removed from cylinder head 130, and UCH housing 200 is cleaned in preparation for engine assembly.

After disassembling UCH housing 200 from cylinder head 130, engine 100 can be assembled. To assemble engine 100, cam shafts 136 and 138 and valve train components, such as valves 132 and 134 and VCT valve assembly 140, are positioned in and/or coupled to cylinder head 130. In the exemplary embodiment, at least one intake valve 132, at least one exhaust valve 134, and cam shafts 136 and 138 are positioned within cylinder head 130. UCH housing 200 is then positioned over cam shafts 136 and 138 and VCT valve assembly 140 such that cams are positioned within cam chambers 220 and VCT valve assembly 140 is positioned within VCT valve body 206. Cam caps 208 and/or fuel pump pedestal 228 are positioned adjacent cradles 144. UCH housing 200 is then coupled to cylinder head 130 using fasteners, such as screws or bolts, at cam caps 208 and fuel pump pedestal 228. Coupling UCH housing 200 to cylinder head 130 retains cam shafts 136 and 138 within cylinder head assembly 112 and/or 114. To service at least the sensors and spark plugs, UCH housing 200 is not required to be dissembled from cylinder head 130.

The above-described embodiments provide an upper cylinder head (UCH) housing that includes a plurality of components formed unitarily therewith. As such, the UCH housing described herein eliminates the need for separate cam caps, VCT valve body, fuel pedestal, oil separator, oil fill hole, dip stick tube, and/or sensor platform. Rather, the functions of each of these components are integrated into the UCH housing described herein. Further, by sculpting the UCH housing to the cam shafts, the overall package design and weight can be reduced as compared to conventional cam covers.

The UCH housing described herein retains the cam shafts within a cylinder head assembly while providing a VCT valve body. The UCH housing also allows access to a fuel pump pedestal to couple a direct inject fuel pump to the UCH housing. Further, during servicing, sensor and/or spark plugs can be replaced without removing the above-described UCH housing. Moreover, the configuration of the above-described UCH housing facilitates eliminating the need for spark plug tubes to reduce engine noise. More specifically, the UCH housing described herein is configured to facilitate reducing noise amplification such that spark plug tubes are redundant.

Exemplary embodiments of an upper cylinder head (UCH) housing for use with an engine and method of making the same are described above in detail. The methods and apparatus are not limited to the specific embodiments described herein, but rather, components of systems and/or steps of the methods may be utilized independently and separately from other components and/or steps described herein. For example, the methods may also be used in combination with other engine systems and methods, and are not limited to practice with only the engine systems and methods as described herein. Rather, the exemplary embodiment can be implemented and utilized in connection with many other engine cover applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An upper cylinder head (UCH) housing for use with a vehicle engine, the UCH housing comprising:
a cover body;
a variable cam timing (VCT) valve body integrally formed with the cover body, the VCT valve body configured to at least partially cover a VCT valve assembly coupled to the vehicle engine; and
a plurality of cam caps integrally formed with the cover body, the plurality of cam caps configured to receive at least a portion of a cam shaft for securing the cam shaft to a cylinder head.

2. A UCH housing in accordance with claim 1, wherein the VCT valve body comprises:
an intake oil control valve port integrally formed with the cover body; and
an exhaust oil control valve port integrally formed with the cover body.

3. A UCH housing in accordance with claim 1, further comprising a plurality of cam chambers defined within the cover body, each cam chamber of the plurality of cam chambers configured to receive at least a portion of a cam mounted to the cam shaft.

4. A UCH housing in accordance with claim 1, further comprising a fuel pump pedestal integrally formed with the cover body, the fuel pump pedestal configured to couple a direct inject fuel pump to the UCH housing.

5. A UCH housing in accordance with claim 1, further comprising an oil separator integrally formed with the cover body, the oil separator extending from an exterior surface of the cover body.

6. A UCH housing in accordance with claim 5, wherein the oil separator further comprises a plurality of walls at least partially extending between exterior surfaces of cam chambers defined in the cover body.

7. A UCH housing in accordance with claim 5, wherein the oil separator further comprises a baffle plate coupled to the cover body and covering the oil separator.

8. A UCH housing in accordance with claim 1, further comprising an oil fill hole integrally formed with the cover body, the oil fill hole in fluid communication with an oil reservoir.

9. A UCH housing in accordance with claim 1, further comprising a dip stick tube integrally formed with the cover body, the dip stick tube configured to receive and retain an oil dip stick therein.

10. A UCH housing in accordance with claim 1, wherein the VCT valve body and the plurality of cam caps are formed unitarily as one piece with the cover body.

11. An engine for use in a vehicle, the engine comprising:
a cylinder head configured to at least partially encase at least one piston and at least one cam shaft;
a variable cam timing (VCT) valve assembly coupled to the at least one cam shaft; and
an upper cylinder head (UCH) housing coupled to an upper portion of the cylinder head, the UCH housing comprising:
a cover body;
a VCT valve body integrally formed with the cover body, the VCT valve body configured to at least partially cover the VCT valve assembly; and
a plurality of cam caps integrally formed with the cover body, the plurality of cam caps configured to receive at least a portion of the least one cam shaft for securing the at least one cam shaft to the cylinder head.

12. An engine in accordance with claim 11, wherein the at least one cam shaft comprises an intake cam shaft and an exhaust cam shaft, and wherein the VCT valve assembly comprises:
an intake valve actuator coupled to the intake cam shaft;
an exhaust valve actuator coupled to the exhaust cam shaft;
an intake oil control valve in flow communication with the intake valve actuator; and
an exhaust oil control valve in flow communication with the exhaust valve actuator.

13. An engine in accordance with claim 12, wherein the VCT valve body comprises:
an intake valve actuator housing at least partially covering the intake valve actuator;
an exhaust valve actuator housing at least partially covering the exhaust valve actuator;
an intake oil control valve port integrally formed as one piece with the cover body, the intake oil control valve coupled within the intake oil control valve port; and
an exhaust oil control valve port integrally formed as one piece with the cover body, the exhaust oil control valve coupled within the exhaust oil control valve port.

14. An engine in accordance with claim 11, wherein the UCH housing further comprises a plurality of cam chambers defined within the cover body, each cam chamber of the plurality of cam chambers configured to receive at least a portion of a cam mounted to the at least one cam shaft.

15. An engine in accordance with claim 11, wherein the UCH housing further comprises an oil separator integrally formed with the cover body, the oil separator comprising:
a plurality of walls extending upwardly from an exterior surface of the cover body and extending between exterior surfaces of cam chambers defined in the cover body; and
a baffle plate coupled to the cover body and covering the plurality of walls to define a flow pathway through the oil separator.

16. An engine in accordance with claim 15, wherein the oil separator is in flow communication with the cylinder head via at least one pick up opening and at least one drain back opening.

17. An engine in accordance with claim 15, wherein the oil separator is in flow communication with an intake manifold of the engine via at least one vapor outlet defined through at least one wall of the plurality of walls.

18. An engine in accordance with claim 11, wherein the UCH housing further comprises a fuel pump pedestal integrally formed with the cover body, the fuel pump pedestal configured to couple a direct inject fuel pump to the UCH housing.

19. An engine in accordance with claim 11, wherein the UCH housing further comprises an oil fill hole integrally formed with the cover body, the oil fill hole in fluid communication with an oil reservoir of the engine.

20. An engine in accordance with claim 11, wherein the UCH housing further comprises a dip stick tube integrally formed with the cover body, the dip stick tube configured to receive and retain an oil dip stick therein.

21. An engine in accordance with claim 11, wherein the VCT valve body and the plurality of cam caps are formed unitarily as one piece with the cover body.

22. A method of making a cylinder head assembly, said method comprising:
providing an upper cylinder head (UCH) housing including a cover body, a variable cam timing valve body integrally formed with the cover body, and a plurality of cam caps integrally formed with the cover body;
coupling the UCH housing to a cylinder head;
machining the UCH housing and the cylinder head together; and
disassembling the UCH housing from the cylinder head.

23. A method in accordance with claim 22, wherein coupling an UCH housing to a cylinder head comprising coupling only the UCH housing to the cylinder head.

24. A method in accordance with claim 22, wherein coupling an UCH housing to a cylinder head comprising coupling the UCH housing to the cylinder head at the plurality of cam caps integrally formed with the cover body.

25. A method in accordance with claim 22, further comprising:
after disassembling the UCH housing from the cylinder head, positioning at least one intake valve, at least one exhaust valve, and at least one cam shaft within the cylinder head; and
coupling the UCH housing to the cylinder head to retain the at least one cam shaft within the cylinder head assembly.

26. A method of making an upper cylinder head (UCH) housing for use with a vehicle engine, the method comprising forming a cover body, a variable cam timing (VCT) valve body, and a plurality of cam caps unitarily as one piece, the VCT valve body configured to at least partially cover a VCT valve assembly coupled to the vehicle engine, the plurality of cam caps configured to receive at least a portion of a cam shaft for securing the cam shaft to a cylinder head.

27. A method in accordance with claim 26, wherein the VCT valve body includes an intake oil control valve port and an exhaust oil control valve port, the method further comprising forming the intake oil control valve port and the exhaust oil control valve port unitarily as one piece with the cover body.

28. A method in accordance with claim 26, further comprising defining a plurality of cam chambers within the cover body, each cam chamber of the plurality of cam chambers configured to receive at least a portion of a cam mounted to the cam shaft.

29. A method in accordance with claim 26, further comprising forming an oil separator unitarily as one piece with the cover body, the oil separator extending from an exterior surface of the cover body.

30. A method in accordance with claim 26, further comprising forming a fuel pump pedestal unitarily as one piece with the cover body, the fuel pump pedestal configured to couple a direct inject fuel pump to the UCH housing.
